(19) United States
(12) Patent Application Publication
(10) Pub. No.: US 2006/0166658 A1
(43) Pub. Date: Jul. 27, 2006

(54) Receiving, recording and forwarding voice messages

(76) Inventors: James D. Bennett, San Clemente, CA (US); Jeyhan Karaoguz, Irvine, CA (US)

Correspondence Address: GARLICK HARRISON & MARKISON LLP, P.O. BOX 160727, AUSTIN, TX, 78716-0727, US

(21) Appl. No.: 11/135,455

(22) Filed: May 23, 2005

Related U.S. Application Data
(60) Provisional application No. 60/646,255, filed on Jan. 24, 2005.

(51) Int. Cl. H04Q 7/20

(52) U.S. Cl. 455/416; 455/417

(57) ABSTRACT

A called party phone and method therefor performed within the called party phone includes receiving a call and corresponding caller ID information, connecting to the received call, playing a pre-recorded message to the calling party, terminating the call and, thereafter, forwarding at least one of caller ID information and time of call to a designated target element. The method further includes, in one embodiment, recording a message from the calling party and forwarding the recorded message as well as message information including at least one of the time of the call and the caller ID of the calling party. The caller ID comprises at least one of a calling party number and a calling party name. In the embodiments in which a recorded message is forwarded to the target element, at least one embodiment of the invention includes attaching the recorded message in the digital format to an email message.

### CROSS REFERENCE TO RELATED APPLICATION

This application claims priority to U.S. Provisional Patent Application Ser. No. 60/646,255, filed Jan. 24, 2005, which is incorporated herein by reference for all purposes.

### BACKGROUND

1. Technical Field

The present invention relates generally to communication systems and, more particularly, voice messaging systems used within wireless and wireline telecommunication networks.

2. Related Art

Communication systems are known to support wireless and wire lined communications between wireless and/or wired communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), wireless application protocol (WAP), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel of the other parties (e.g., one of the plurality of radio frequency (RF) carriers of the wireless communication system) and exchange information over that channel. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wire lined or wireless network.

Each wireless communication device includes a built-in radio transceiver (i.e., receiver and transmitter) or is coupled to an associated radio transceiver (e.g., a station for in-home and/or in-building wireless communication networks, RF modem, etc.) to participate in wireless communications. As is known, the receiver receives RF signals, removes the RF carrier frequency from the RF signals via one or more intermediate frequency stages, and demodulates the signals in accordance with a particular wireless communication standard to recapture the transmitted data. The transmitter converts data into RF signals by modulating the data in accordance with the particular wireless communication standard and adds an RF carrier to the modulated data in one or more intermediate frequency stages to produce the RF signals.

With respect to landline networks, two of the largest networks in the world are the public switched telephone network (PSTN) and the Internet, which is optimized for data packet transmission and routing. The PSTN, which also serves as the largest worldwide computer network, is specialized for voice and has traditionally comprised large-scale circuit switching for routing calls from one point to another. Originally, in the plain old telephone system (POTS), a trunk would be set up between at least two switches as a part of call setup between the calling party and the called party. Later, with the advent of advanced intelligent networks (AINs), a local loop, namely the connection from the landline phone to a switch in the central office, remained analog, while the connectivity between switches transitioned to digital signaling at least in a control plane. As such, in an AIN network, call routing is performed on a routing plane prior to the actual connection of a trunk on a voice plane between the calling party and the called party.

The PSTN originated in 1876 and comprised a combination of central offices and local loops between the landline phones and the switches of the central offices. Indeed, initially a plurality of landline phones share one phone line in a so called party line. Over time, each residential unit was allocated its own local loop to establish connectivity between the phones in its premises and a switch in the central office. Then, over time, the digital networks between the central offices developed to facilitate worldwide voice and data communications. However, because of the high cost of long distance and international calls and data transfers, a need for cheaper connectivity supported efforts for the development of the Internet, which, now, provides substantial portions of all data packet transfers. Indeed, significant efforts are under way to even provide voice over the Internet in the so-called voice over IP protocol.

At the same time that such technologies developed, a need also existed for technology to record messages from a calling party when the called party was unavailable. Thus, in the late 1970s and early 1980s, analog tape-based answering machines were developed and marketed to enable a calling party to leave a message. Realizing the benefits of providing such services without requiring users to own such bulky and cumbersome answering machines, the phone companies developed voice messaging services, for a fee, to enable the network to record any messages for the called parties. At the same time, because such features had an associated cost, a need continued to exist for better answering machines. Thus, digital answering machines with integrated phone sets have been developed and are still quite popular today. Along the same lines, as the cellular networks and markets have developed and expanded, voice mail has become a standard feature for nearly all cell phone users. Moreover, as voice messaging has become prevalent, so has email text messaging.

The aforementioned technology efforts with respect to providing messaging services including voice mail for users has been very beneficial and has led to greater communications than before. However, many people travel so extensively that it becomes a project to merely retrieve all of the voice mail from a plurality of locations. For example, a traveler may have to retrieve voice mail from a home phone, a business phone, and a cell phone, in addition to retrieving email messages while on a trip. Given the proliferation of junk mail, unsolicited spam, unsolicited telemarketing, and other such undesirable invasions of message-recording media, retrieving messages can be a cumbersome task.

One solution provided in the past for the traveler is that of call and email forwarding. One problem with such approach, however, is that all calls and email messages are forwarded to a designated phone number or email address. The traveler, however, may prefer to selectively listen to recorded messages. There is a need, therefore, for providing at least an indication of a call, if not providing an actual recorded message, to a user without requiring an incoming call to be routed to the user. As such, the user is able to selectively monitor messages without the shortcomings described above.

### SUMMARY OF THE INVENTION

A called party phone operable to receive and terminate a call is further operable, after completion of the call, to automatically initiate, without user prompting, an outgoing call to a specified target element to provide message information to the target element. The message information includes, at least an indication that a call was received and a time the call was received. In various embodiments, the message information includes at least one of caller ID information and a recorded message. The caller ID information may be provided in the form of a text message such as an SMS message, a text message, an email message or any other messaging system. The recorded message may be provided in the form of a text as generated by voice-to-text voice translation logic or in the form of common audio file including MP3 compressed audio files, WAV audio files, and the like.

The called party phone includes transceiver for receiving a call and corresponding caller ID information, circuitry for connecting to the received call, circuitry for playing a pre-recorded message to the calling party, wherein the called party phone is operable to play a message to the calling party and to terminate the call upon receiving an indication that the calling party is no longer connected to the call. The called party phone further includes circuitry for forwarding caller ID information and time of call to a message target agent, which message target agent is specified at a time prior to the call.

In one embodiment of the invention, the message is recorded in an analog format and then is converted to a digital format. For example, the message may be recorded to a WAV format. Alternatively, the message is recorded in a digital format. After recording, the called party phone is operable to compress the message to reduce storage size and transmission time. The called party phone is further operable to attach the recorded digital message to an email message and to transmit the email message.

In one embodiment, the called party phone is operable to generate outgoing call signals to establish a communication link with a specified landline phone or wireless phone for delivery to the specified landline or wireless phone. Alternatively, the called party phone is operable to establish a communication link with one of an SMS server, voice mail server (for example, such as an interactive voice response unit or system), text page server or email server by phone of a public switched telephone network or wireless phone network. As yet another alternative, the embodiment of the invention includes circuitry for and is operable to generate outgoing messages over a data packet network, such as the Internet, to a target element.

A method performed within a called party phone includes receiving a call and corresponding caller ID information, connecting to the received call, playing a pre-recorded message to the calling party, terminating the call and, thereafter, forwarding at least one of caller ID information and time of call to a designated target element. The method further includes, in one embodiment, recording a message from the calling party and forwarding the recorded message as well as message information including at least one of the time of the call and the caller ID of the calling party. The caller ID comprises at least one of a calling party number and a calling party name. In the embodiments in which a recorded message is forwarded to the target element, at least one embodiment of the invention includes attaching the recorded message in the digital format to an email message.

The method further includes generating outgoing call signals to establish a communication link with a specified landline phone or with a cellular phone for delivery to the specified landline or cellular phone, respectively. Alternatively, a communication link may be established with one of a voice mail server for retrieval by a specified recipient, an email server to deliver a text message to the email server for further delivery to a specified recipient in the form of an email message, an SMS message server to deliver a text message to the SMS message server for further deliver to a specified recipient in the form of an SMS message, or a private branch exchange (PBX) phone.

One aspect of establishing a communication link with a specified target element is to establish a communication link over one of a public switched telephone network or a wireless phone network. An alternative embodiment includes, however, circuitry and a method for delivering the message information as described above either with or without a recorded message over a data packet network.

Other aspects of the present invention will become apparent with further reference to the drawings and specification, which follow.

### BRIEF DESCRIPTION OF THE DRAWINGS

A better understanding of the present invention can be obtained when the following detailed description of the preferred embodiment is considered with the following drawings, in which:

FIG. 1 is a functional schematic diagram of a global communication network that further illustrates connectivity between a plurality of large and global networks that collectively operate according to one embodiment of the present invention;

FIG. 2 is a functional block diagram of a communication network formed according to one embodiment of the present invention;

FIG. 3 is a functional block diagram of a wireless network that operates according to one embodiment of the present invention;

FIG. 4 is a schematic block diagram of a phone formed according to one embodiment of the present invention;

FIG. 5 is a signal flow diagram illustrating operation in a network according to one embodiment of the present invention; and

FIG. 6 is a flow chart that illustrates operation according to one embodiment of the present invention.

### DETAILED DESCRIPTION

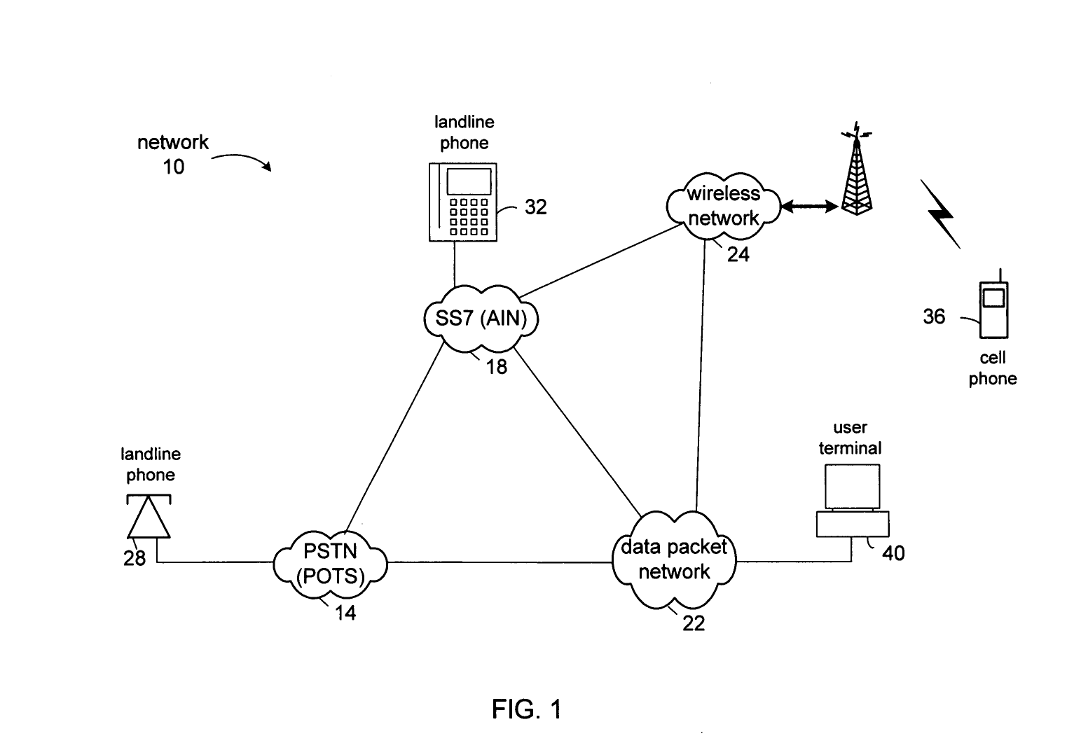

FIG. 1 is a functional schematic diagram of a global communication network that further illustrates connectivity between a plurality of large and global networks that collectively operate according to one embodiment of the present invention. Referring now to FIG. 1, a network 10 is shown, which comprises a plurality of network elements that are each coupled to users through corresponding user terminals. Specifically, a POTS network 14 of a PSTN is coupled to an SS7 network 18 also of the PSTN, as well as to a data packet network 22. Each of SS7 network 18 and data packet network 22 are coupled to each other, as well as to a wireless network 24.

Continuing to examine FIG. 1, a landline phone 28 may readily complete a call with landline phone 32 or cell phone 36 through networks 14 and 18. Additionally, a computer connected to landline phone 28 may complete a connection with user terminal 40 by way of POTS network 14 and data packet network 22. For example, if a modem and user terminal is connected to landline phone 28, or alternatively, a fax machine is connected to landline phone 28, data may be exchanged between landline phone 28 and user terminal 40 by way of PSTN 14 and data packet network 22.

In the example shown in FIG. 1, the connection between landline phone 28 and POTS network 14, as well as the connection between landline phone 32 and SS7 network 18, is an analog connection that is known as a local loop. The connectivity within SS7 network 18, and between SS7 network 18, wireless network 24, and data packet network 22, however, is all digital. Typically, a local loop has a link that is less than or equal to 6 miles. The switches in the central offices that provide the switching for each of the landline phones 28 and 32 are known as local exchanges. Moreover, referring specifically to landline phone 32, a sub-network may readily replace landline phone 32. For example, landline phone 32 may well be replaced by a private branch exchange (PBX) which is a telephone system within an enterprise that switches calls within the enterprise on local lines. A PBX allows all users within the enterprise to share a certain number of external lines to the central office. A great advantage of a PBX is that the cost of requiring a line for each employee of the enterprise is reduced, thereby saving operating expenses for the enterprise. As such, the aspects of the present invention that are described in relation to landline phones 32, also apply to a PBX network and associated phones.

According to one aspect of the present invention, a landline phone, for example, landline phone 32, is operable to receive a call from landline phone 28, record a message, and forward at least information regarding the call message, if not the actual recorded message, to a phone or device as specified by a user. Generally, such a device or phone to which message information is forwarded shall be referred to herein as a message target element. Accordingly, if the user of landline phone 32 wishes to forward message information to cell phone 36, then landline phone 32 is operable to receive a phone number of cell phone 36 to facilitate transmitting message information thereto.

More specifically, as a part of establishing a call, landline phone 32 will at least know the time that a message was left thereon. If landline phone 28 is connected to a phone network, which does not have caller ID capability, then landline phone 32 may not receive caller ID information. If, however, landline phone 28 is connected to an intelligent network switch, such as an SS7 switch, then landline phone 32 also receives at least one of a calling party phone number and calling party name (singularly or collectively “caller ID”). Thus, according to the aspect described of the present invention, landline phone 32 is operable to produce the caller ID and time of call through SS7 network 18 and wireless network 24 to cell phone 36. As an additional aspect of the present invention, landline phone 32 is operable to also produce the recorded message in a digital form to cell phone 36 by way of SS7 network 18 and wireless network 24. As another aspect of the present invention, landline phone 32 is further operable to generate a text message identifying the call in the form of an email message, a text page, or a short message service (SMS) message that are respectively delivered to a page server, an email server, or an SMS server, respectively. Such components are commonly found within the SS7 network and are therefore not shown herein FIG. 1. Optionally, a recorded message may also be provided in the format of an audio file (e.g., MP3, WAV, etc.) or text (produced by voice recognition logic). The recorded message may also be delivered in any known delivery form including delivery as an attachment to an email message.

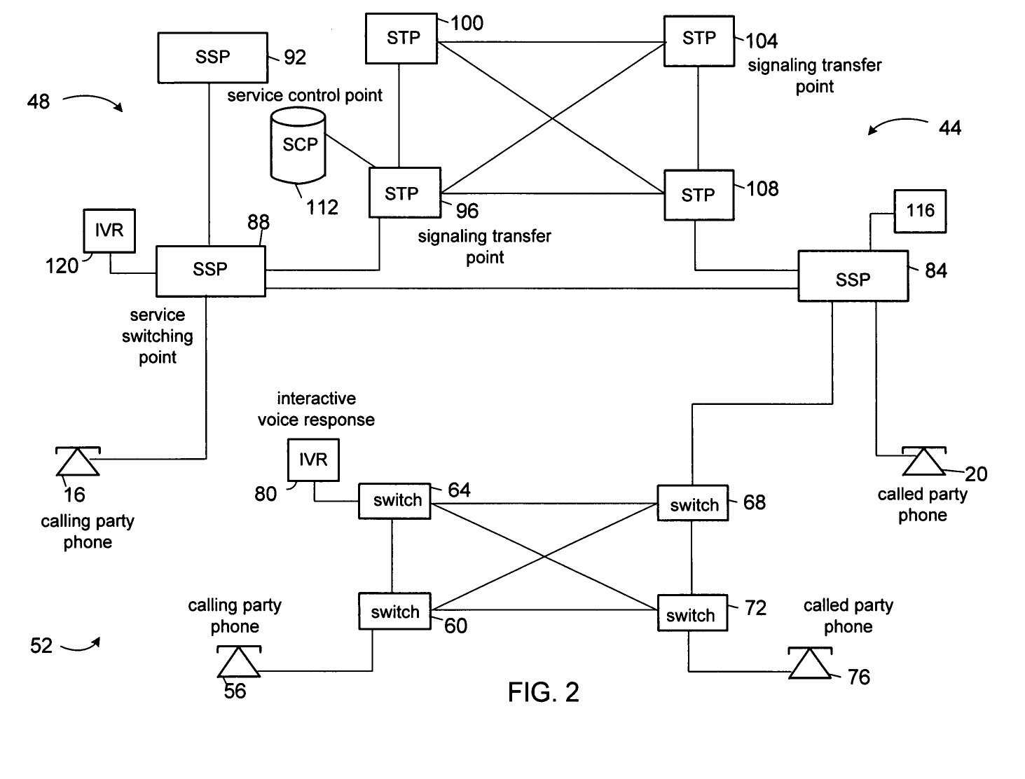

FIG. 2 is a functional block diagram of a communication network formed according to one embodiment of the present invention. A network shown generally as network 44 includes two network portions comprising an SS7 network 48 and a POTS network 52. As may be seen, a calling party phone 56 is coupled to a switch 60 of POTS network 52. Switch 60 is further coupled to switches 64, 68 and 72. Additionally, a called party phone 76 is coupled to switch 72. Accordingly, when calling party phone 56 goes off-hook, and the user dials a phone number for called party phone 76, a trunk is established between switch 60 and switch 72 as the call is routed to called party phone 76.

One known problem of such topology is that resources are wasted to establish a trunk between switches 60 and 72 even if the called party is not available. As may further be seen, POTS network 52 is coupled to SS7 network 48, and more specifically, to service switching point 84. A service switching point (SSP) is a public switched telephone network switch that can recognize intelligent network calls and route or connect the calls based on routing information provided by a signaling transfer point. A signaling transfer point is a packet switch in the control plane of the SS7 network that converts dialed digits to data messages to perform call routing and is coupled to a service control point to obtain routing information.

A service control point (SCP) is a remote database within the intelligent network that supplies translation of data and routing data needed to deliver the intelligent network services. For example, a dialed phone number may be translated to a required routing number by the SCP. The SCP, it should be noted, is not an actual switch, but merely provides switching control. As such, the SCP introduces an ability for advanced new services on the telephone network.

In the SS7 network 48, an interactive voice response server may be coupled to the SSPs. As may be seen, with the above definitions in mind, SS7 network 48 not only includes SSP 84 but also SSP 88 and 92. Additionally, SS7 network 48 includes STPs 96, 100, 104 and 108. Finally, an SCP 112 is coupled at least to STP 96 to provide routing support therefor.

Because the local loop in the PSTN is an analog local network leg, a POTS switch, such as POTS switch 60 or an SS7 switch, such as SSP 88, must be able to couple to the landline phones through an analog connection. As described above, however, if the landline phone is connected to an SS7 network element, more particularly, SSPs such as SSP 88, then SCP 112 and STP 96 will provide routing support for the call from the landline phone coupled to SSP 88. Advantageously, SS7 network 48 is further operable to provide calling party ID information as a part of delivering call setup signals to a called party phone.

Continuing to examine FIG. 2, typical operation includes the use of an interactive voice response (IVR) unit or system, such as IVR 80 or IVR 120, coupled to a network element providing voice mail capabilities. For example, if calling party phone 16 dials the digits associated with called party phone 20, the SS7 network 48 is operable to connect the call to an associated IVR, such as IVR 116, to play back a message to the calling party and to enable the calling party to leave a message for called party phone 20 if called party phone 20 is off hook (in use) or if there is not answer after a specified number of rings.

According to the present invention, however, a called party phone, such as called party phone 20, is operable to play back a prerecorded message to the calling party without requiring an IVR to record any messages left by the calling party. Additionally, called party phone 20 is operable to generate calling signals to provide message information to a specified target element in a specified manner. For example, called party phone 20 may automatically initiate a call and mesage, after receiving a call, by opening the connection to SSP 84 and generating dialed digit tones in the form of DTMF tones for a specified message target element to provide notification of the received call including, optionally, any one of the different types and amounts of message information. As described before, the message target element may be a cell phone, a landline phone, a voice mail server, an email server, or an SMS message server.

In one embodiment of the invention, the message information merely includes an indication of the time that a message was left. In another embodiment of the invention, the message information includes caller ID for the called party that left the message. In a yet another embodiment of the present invention, the message information includes the caller ID information, the time the message was left, and actual content of the message in one of text, recorded voice, or computer generated voice formats. Moreover, the actual content of the message may be delivered in a voice format over a bearer channel established by the phone to deliver message information, or as digital data for conversion to audio at a receiving end.

In one alternate embodiment of the invention, the voice message is converted to text using voice recognition software that is embedded within the called party phone. The corresponding text is then provided as a part of the message information. In those embodiments in which text is produced as part of the message information, the text may be produced as an SMS message that is generated by the called party phone, or as an email message, or as an attachment to an email message that is generated by the called party phone.

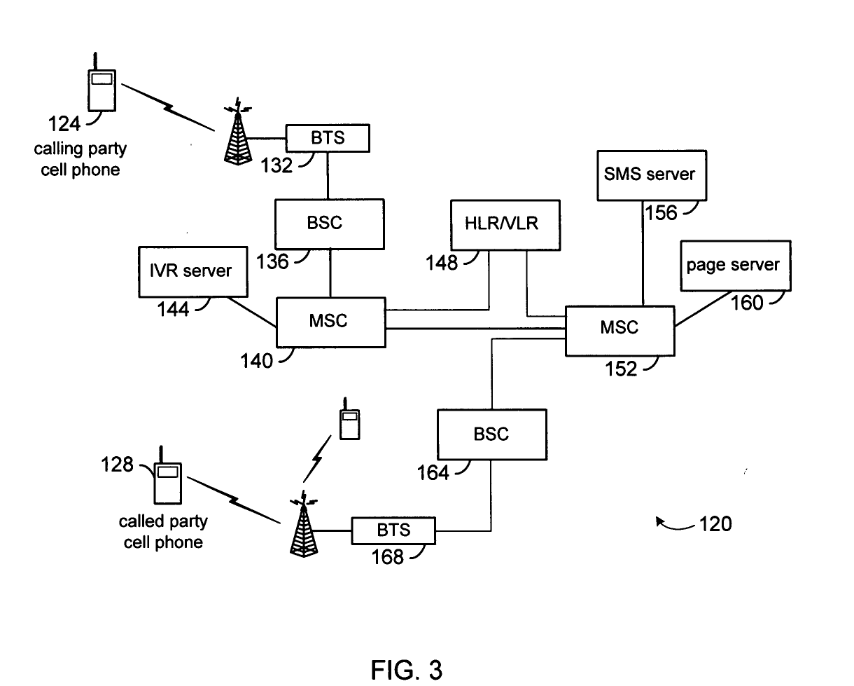

FIG. 3 is a functional block diagram of a wireless network that operates according to one embodiment of the present invention. As may be seen, a wireless network 120 which, by way of example, may be the equivalent of wireless network 24 of FIG. 1, includes a plurality of cell phones that are operably coupled through a plurality of wireless network 120 network elements. Typical network elements include base transceiver stations (BTSs) that provide RF circuitry, base station controllers (BSCs) that provide control of communications in the BTSs, mobile switching centers (MSCs) that provided call switching, home location registers (HLRs) that provide subscriber and location information in conjunction with visitor location registers (VLRs). The network further provides IVR and SMS servers that provide voice and text messaging services, respectively.

In the specific embodiment shown, if a calling party utilizing cell phone 124 generates a call to called party cell phone 128, the call must be routed through the wireless network 120. More specifically, for exemplary purposes, a BTS 132 is coupled to an antenna tower to receive communication signals from calling party cell phone 124 and is further coupled to BSC 136 which in turn is coupled to MSC 140. MSC 140 is further coupled to an IVR server 144, an HLR/VLR 148 that monitors locally registered terminals and corresponding subscriber information, and an MSC 152. MSC 152 is coupled to an SMS server 156 and a page server 160. MSC 152 is further coupled to BSC 164, which in turn is coupled to BTS 168. Substantial details of the operation of wireless network 120 is known by one of average skill in the art. Generally, however, MSC 140 will communicate with HLR/VLR 148 to determine a serving BTS for called party cell phone 128. Through known mechanisms, HLR/VLR 148 is made aware of the location of called party cell phone 128 through registration processes and identifies MSC 152 as a serving MSC for called party cell phone 128. MSC 152 routes an incoming call for called party cell phone 128 through BSC 164 and BTS 168 to establish a wireless communication link between BTS 168 and called party cell phone 128.

In a traditional wireless network, an IVR server 144 would play a message back to calling party cell phone 124 if the called party cell phone 128 does not answer after a specified number of rings or is busy. Moreover, as an additional service, an IVR server 144 will typically also enable the calling party using calling party cell phone 124 to leave a message for the user of called party cell phone 128. Thereafter, the user of called party cell phone 128 merely retrieves the messages from IVR server 144 at a convenient time. While traditional cellular networks utilize the IVR to record voice messages, the present embodiment of the invention contemplates the wireless terminal recording at least one of call information (e.g., caller ID information and time of call) and actual messages left by the calling party. Thereafter, the wireless terminal transmits message information to a designated message target element.

For example, if called party cell phone 128 generates an SMS message identifying the call, called party cell phone 128 generates an SMS message that is delivered to SMS server 156. Alternatively, if called party cell phone 128 generates a page, then the page is delivered to page server 160. In the embodiments of the invention in which called party cell phone 128 further includes circuitry for recording a voice message and for playing back a prerecorded voice message to the calling party, the called party cell phone 128 is operable to transmit the voice message to the message target element. In one embodiment, actual voice is transmitted through the wireless network 120 in an analog form as if a call were being conducted there through. In an alternate embodiment of the invention, however, called party cell phone 128 converts a received voice message to text and generates a corresponding text message for delivery to the message target element.

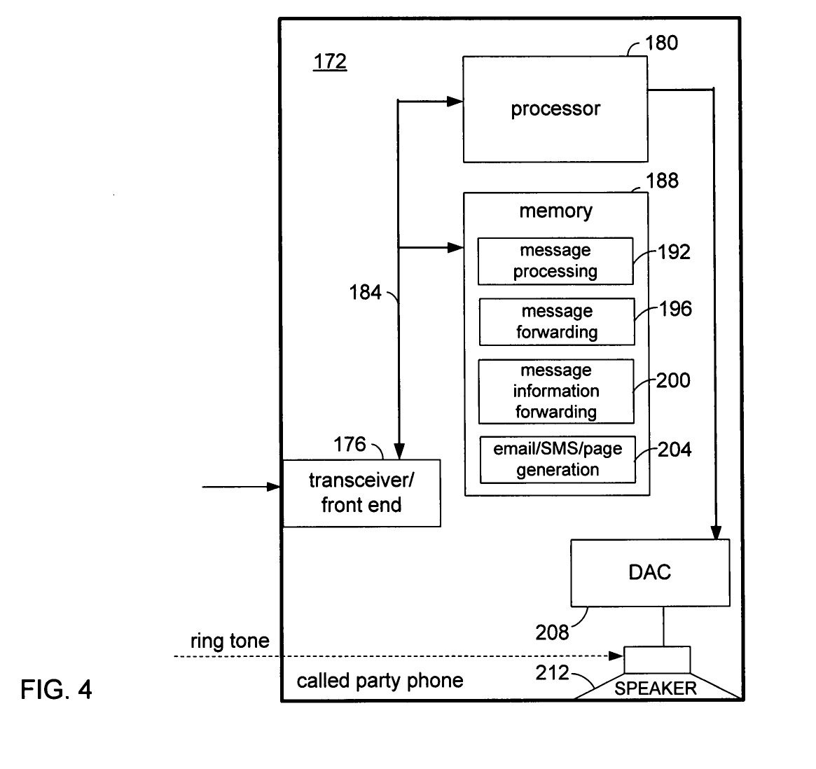

FIG. 4 is a schematic block diagram of a phone formed according to one embodiment of the present invention. The phone of FIG. 4 generally represents circuitry that may be found either within a landline phone or within a cellular phone. According to the host device, a phone 172 comprises a transceiver/front end 176 that receives call signals, including calling party ID signals. For example, the transceiver fron end includes RF fron end radio circuitry in a wireless cell phone and in a landline phone, comprises traditional wireleine analog voice transceiver circuitry. In either type of host device, phone 172 comprises a processor 180 that is operably coupled to communicate with transceiver/front end 176 over a bus 184. Processor 180 further communicates with a memory 188 over bus 184. Memory 188 comprises computer instructions that define logic for message processing, message forwarding, message information forwarding, and email/SMS/page message generation. Functionality and logic of the computer instructions is represented, respectively, as blocks 192, 196, 200 and 204 for each of the aforementioned groups of computer instructions.

Operationally, these computer instructions are executed by processor 180 to define and achieve the desired operational logic and may readily be substituted in hardware by corresponding defined logic blocks. Accordingly, the example of FIG. 4 illustrates memory 188 as having four logic blocks 192, 196, 200 and 204 that define the aforementioned functionality.

Processor 180 is further coupled to a digital-to-analog converter (DAC) 208 for converting digital audio to analog audio that is produced to a speaker 212. Additionally, as may be seen, speaker 212, if implemented in a landline phone, is further coupled to receive a ring tone, as is shown by the dashed lines 210 in FIG. 4. Referring again to the computer instructions that define the four logic blocks within memory 188, message processing logic block 192 defines logic for recording an incoming voice message. Message forwarding logic block 196 includes logic for forwarding a message to a specified message target element that has been previously identified by a unique ID, address or phone number.

Message information forwarding logic block 200 defines logic for forwarding at least the time that a call was received to the specified message target element. Additionally, message information forwarding logic block 200, in one embodiment of the invention, also forwards caller ID information. Email/SMS/page generation logic block 204 defines logic for generating and transmitting one of an email message, an SMS message, or a text page that includes at least some information provided by message information forwarding logic block 200. In one embodiment of the invention, email/SMS/page generation logic block 204 also includes logic for attaching one of an audio file, for example, an MP3 file which comprises compressed audio, or a text file including text that represents a voice message as produced by logic block 196. It is readily understood that message forwarding may occur in one of a plurality of manners. For example, a message may be produced in a digital form to transceiver/front end 176 for conversion to analog audio for transmission over a phone line.

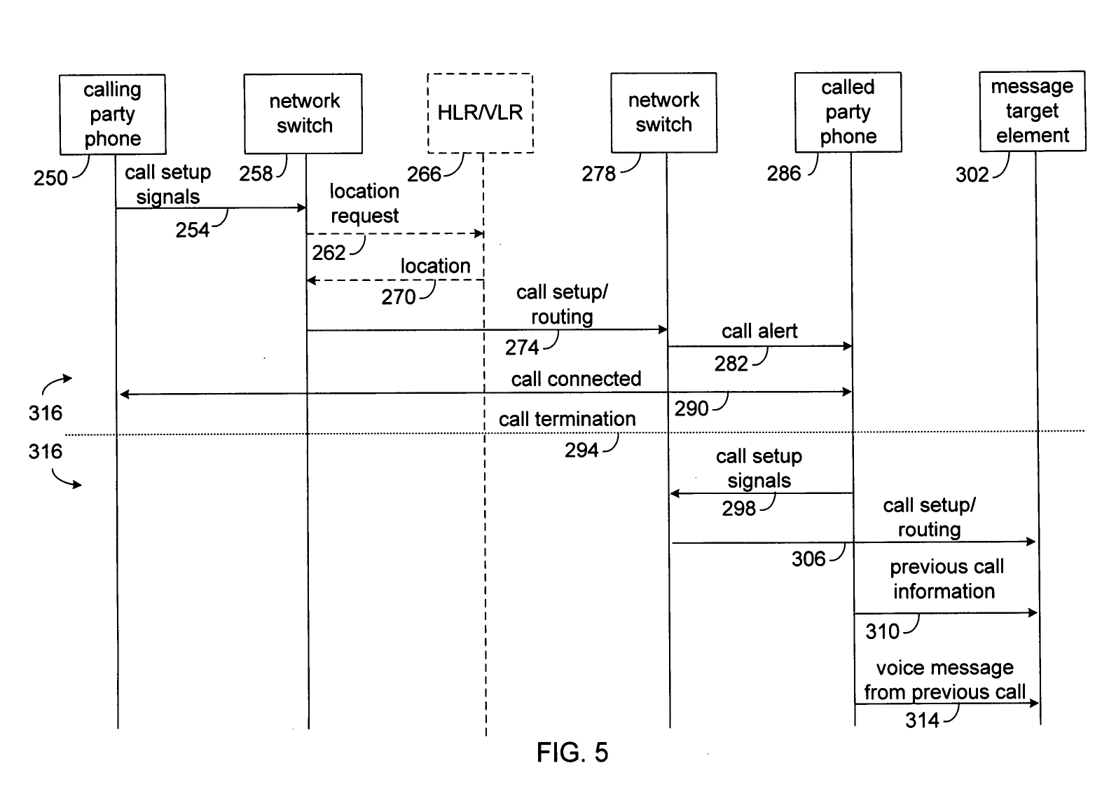

FIG. 5 is a signal flow diagram illustrating operation in a network according to one embodiment of the present invention. More specifically, the signal flow diagram of FIG. 5 illustrates the flow of signals to set up a call outside of the inventive called party phone and the response of the called party phone based on such call signaling. Initially, a calling party phone 250 generates call setup signals 254 to a network switch 258. The network switch 258 may comprise either an older technology switch, such as that found in the plain old telephone system networks, or a service switching point as found in an SS7 network.

Alternatively, if the network is a cellular network, the network switch may comprise a BSC or MSC. For the purposes of the present invention, operation of the BSC and MSC may be combined, as specific operation of such is well known in the art. If the embodiment is implemented in a cellular network, network switch 258 may optionally generate location request signals 262 to an HLR/VLR 266, which, responsive thereto, returns location information 270. Based upon the received location information, or in a situation where the location is known in a landline network, network switch 258 generates call setup/routing signals 274 to network switch 278. Network switch 278 then generates call alert signals 282 to the called party phone 286. Thereafter, the call is connected as shown at 290. After the call is connected, while not specifically shown herein, a message may be played back to the calling party phone 250. Moreover, optionally, the calling party on the calling party phone may choose to record a message for the called party. Thereafter, the call is terminated, as shown at 294.

Once the call is terminated, the called party phone 286, on its own, initiates call setup signals 298 to network switch 278. The call setup signals are to establish a call connection or to deliver a text message to a message target element, such as message target element 302 here in FIG. 5. Network switch 278 then routes call setup signals and performs call message routing, as shown at 306, to establish a link with message target element 302. Thereafter, either directly or by way of the network switch 278, called party phone 286 produces message information to the message target element. Here, the called party phone generates previous call information 310 that is delivered to message target element 302 and, optionally, a voice message from the previous call, as shown at 314.

For simplicity, not all of the connectivity is shown. It is understood, however, that the called party phone 286 generates call or message information that is delivered to the message target element 302. For example, if the message target element is another phone, either landline or cell phone, then called party phone 286 may establish a call connection thereto to deliver the call information and optionally the stored voice message from the previous call.

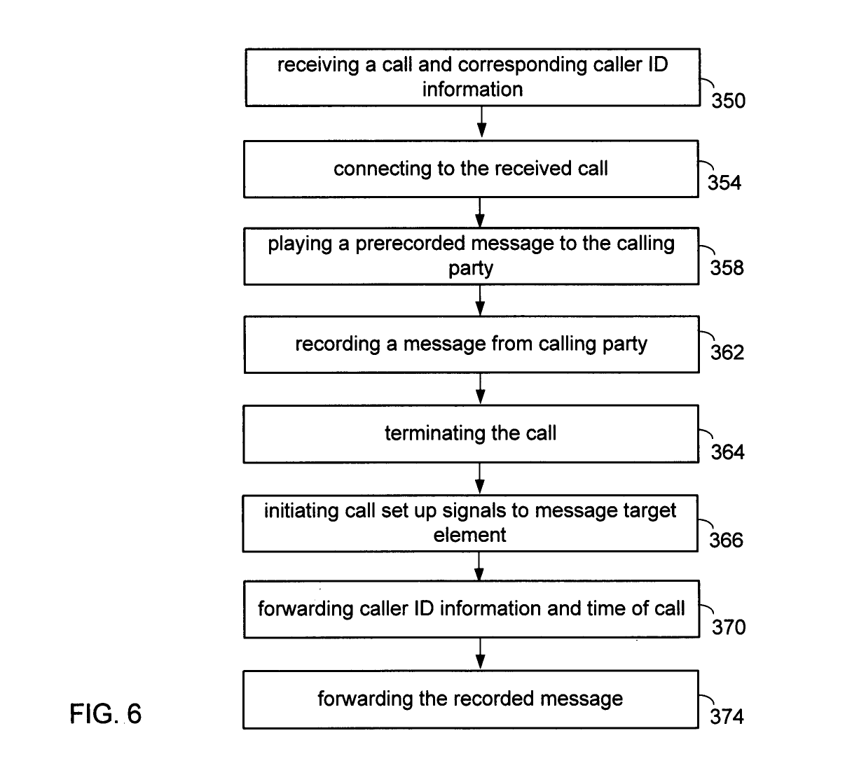

FIG. 6 is a flow chart that illustrates operation according to one embodiment of the present invention. More specifically, the method of FIG. 6 is performed by a landline phone though, in an alternate embodiment of the invention, it may be performed by a cell phone as well. Initially, the method of FIG. 6 includes receiving a call and corresponding caller ID information (step 350). Thereafter, the landline phone, having an associated answering machine, connects to the received call (step 354) and plays a prerecorded message to the calling party (step 358). Optionally, the invention includes recording a message from the calling party (step 362) and terminating the call (step 364).

After the call has been terminated in step 364, the embodiment of the invention includes initiating call setup signals to a message target element (step 366). The message target element is identified in advance by one of a unique address or ID. In one embodiment, the unique address or ID is a unique phone number. The message target element may comprise one of a cell phone, a landline phone, a PBX, an email server, an SMS server, or a page server. After initiating the call setup signals to the message target element, the invention includes forwarding caller ID information, if available, and time of call (step 370). Finally, as an optional aspect of the present invention, the method includes forwarding the recorded message that was optionally recorded in step 362 (step 374). In one embodiment of the present invention, a call is setup to the message target element and the recorded message is played back as an audio message to the message target element for delivery thereto. In an alternate embodiment of the invention, the recorded message is transmitted to the message target element as digital data. In one specific embodiment, the recorded message is transmitted as a text message that has been converted to text from a voice recognition software algorithm.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As one of average skill in the art will appreciate, other embodiments may be derived from the teaching of the present invention, without deviating from the scope of the claims.

What is claimed is:

1. A method in a called party phone, comprising:
receiving a call and corresponding caller ID information;
connecting to the received call;
playing a pre-recorded message to the calling party;
terminating the call;
forwarding call information including at least one of caller ID information and time of call.

2. The method of claim 1 further including recording a message from the calling party and forwarding the recorded message as a part of the call information.

3. The method of claim 2 further including storing the recorded message in digital format.

4. The method of claim 3 further including attaching the recorded message in the digital format to an email message.

5. The method of claim 1 further including generating outgoing call signals to establish a communication link with a specified landline phone for delivery of the caller information to the specified landline phone.

6. The method of claim 2 further including generating outgoing call signals to establish a communication link with a cellular phone for delivery to a specified recipient utilizing a data packet protocol wherein the call information is transmitted within a payload field.

7. The method of claim 2 further including generating outgoing call signals to establish a communication link with a voice mail server for retrieval by a specified recipient wherein the call information including at least one of time of call, caller ID and recorded message is uploaded to the voice mail server containing call information.

8. The method of claim 2 further including generating outgoing call signals to establish a communication link with an email server to deliver a text message to the email server for further delivery to a specified recipient in the form of an email message.

9. The method of claim 2 further including generating outgoing call signals to establish a communication link with an SMS message server to deliver a text message to the SMS message server for further deliver to a specified recipient in the form of an SMS message.

10. The method of claim 1 wherein the method is performed by one of a cellular phone, a landline phone, or a private branch exchange (PBX) phone.

11. A called party phone, comprising:
transceiver for receiving a call and corresponding caller ID information;
circuitry for connecting to the received call;
circuitry for playing a pre-recorded message to the calling party, wherein the called party phone is operable to play a message to the calling party and to terminate the call upon receiving an indication that the calling party is no longer connected to the call; and
circuitry for forwarding call information including at least one of caller ID information and time of call to a message target agent, which message target element is specified at a time prior to the call.

12. The called party phone of claim 11 wherein the called party phone is operable to record a message from the calling party and forward the recorded message to the message target element.

13. The called party phone of claim 12 wherein the called party phone is operable to record and store the recorded message in a digital format.

14. The called party phone of claim 13 wherein the called party phone is operable to attach the recorded message in the digital format to an email message.

15. The called party phone of claim 12 wherein the called party phone is operable generate outgoing call signals to establish a communication link with a specified landline phone for delivery to the specified landline phone.

16. The called party phone of claim 12 further wherein the called party phone is operable to generate outgoing call signals to establish a communication link with a specified cellular phone for delivery to a specified recipient.

17. The called party phone of claim 12 further wherein the called party phone is operable to generate outgoing call signals to establish a communication link with a specified voice mail server for retrieval by a specified recipient.

18. The called party phone of claim 12 wherein the called party phone is operable to generate outgoing call signals to establish a communication link with a specified email server to deliver a text message to the email server for further delivery to a specified recipient in the form of an email message.

19. The called party phone of claim 12 wherein the called party phone is operable to generate outgoing call signals to establish a communication link with a specified SMS message server to deliver a text message to the SMS message server for further deliver to a specified recipient in the form of an SMS message.

20. The called party phone of claim 12 wherein the called party phone comprises one of a cellular phone, a landline phone, or a private branch exchange (PBX) phone.

21. A called party phone, comprising:
circuitry for receiving message target element information;
transceiver for receiving a call and corresponding caller ID information;
circuitry for connecting to the received call;
circuitry for playing a pre-recorded message to the calling party, wherein the called party phone is operable to play a message to the calling party and to terminate the call upon receiving an indication that the calling party is no longer connected to the call; and
circuitry for forwarding caller ID information and time of call to the message target element based upon the message target element information.

22. The called party phone of claim 21 wherein the message target element comprises one of a cellular phone, a landline phone, a PBX phone, a voice mail server, an email server, and an SMS message server.

23. The called party phone of claim 21 wherein the called party phone is operable to forward a recorded message from the calling party to an ordered list of message target elements based upon the message target element information.

24. The called party phone of claim 23 wherein the calling party information comprises a text message and further wherein the message target element is one of an email server or an SMS message server.
